(19) United States
(12) Patent Application Publication
(10) Pub. No.: US 2011/0217607 A1
(43) Pub. Date: Sep. 8, 2011

(54) ANODE UTILIZATION CONTROL SYSTEM FOR A FUEL CELL POWER PLANT

(76) Inventor: Joshua Isom, South Windsor, CT (US)

(21) Appl. No.: 13/127,129

(22) PCT Filed: Dec. 1, 2008
(86) PCT No.: PCT/US08/13246

§ 371 Date: May 2, 2011

(51) Int. Cl. H01M 8/06

(52) U.S. Cl. 429/423

(57) ABSTRACT

The control system (10) utilizes an oxygen sensor (78) to sense an oxygen concentration within a burner exhaust (66) of a fuel processing system (40), wherein the burner device (44) utilizes an anode exhaust stream from a fuel cell (12) to supply heat to a reformer (48). If the anode utilization by the fuel cell (12) anode (14) exceeds an acceptable range, less hydrogen is available for the burner device (44) and more oxygen will therefore be sensed by the oxygen sensor. An oxygen sensor controller (80), in response to the increase in sensed oxygen, increases flow of a fuel feedstock (42) into the reformer (48) to provide more hydrogen fuel to the anode (14) to thereby return anode utilization to an acceptable anode utilization range. An opposite control sequence occurs if anode utilization falls below the acceptable range.

### TECHNICAL FIELD

The present disclosure relates to fuel cell power plants that are suited for usage in transportation vehicles, portable power plants, or as stationary power plants, and the disclosure especially relates to a system and method for controlling use of a hydrogen-rich fuel at an anode of a fuel cell power plant that utilizes fuel produced by a reformer within a fuel processing system of the plant.

### BACKGROUND ART

Fuel cells are well known and are commonly used to produce electrical current from a hydrogen-rich fuel stream and an oxygen-containing oxidant stream to power electrical apparatus. Fuel cells are typically arranged in a cell stack assembly having a plurality of fuel cells arranged with common manifolds and other components such as a fuel processing system, controllers and valves, etc. to form a fuel cell power plant. In such a fuel cell power plant of the prior art, it is well known that fuel is produced by the fuel processing system reformer and the resulting hydrogen-rich fuel stream flows from the reformer through a fuel inlet line into anode flow fields of the fuel cells. An oxygen stream simultaneously flows through cathode flow fields of the fuel cells to produce electricity.

Fuel cell power plants are known to provide electricity for differing types of apparatus. For example, many efforts are being undertaken to produce a fuel cell power plant utilizing “proton exchange membrane” (PEM) electrolyte fuel cells to power transportation vehicles. Fuel cells utilizing phosphoric acid electrolytes are also known to power stationary electricity generating plants. In such fuel cell power plants, it is known to use a fuel processing system having a reformer that undergoes an endothermic reaction therefore requiring addition of heat, such as a catalytic steam reformer.

One source of heat for such reformers is provided by excess hydrogen leaving fuel cells of the plant within an anode exhaust stream. The anode exhaust stream is directed to a burner device and ignited. In a phosphoric acid electrolyte fuel cell (“PAFC”) power plant, heat from the ignited exhaust is transferred by way of a convection and conduction to the reformer catalyst to supply energy to the endothermic reacting reformer. In a proton exchange membrane electrolyte (“PEM”) power plant, heat from the ignited exhaust may be used to heat a water supply into steam which is then directed into a reformer to transform a hydrocarbon fuel feedstock into hydrogen gas and carbon by-products. The hydrogen gas is then directed through a fuel inlet line into anode flow fields of the fuel cells. As described in U.S. Pat. No. 6,818,336 that issued on Nov. 16, 2004 to Isom et al., which patent is owned by the owner of all rights in the present invention, it is known to control flow of the fuel feedstock into a reformer as a function of properties of steam within the reformer and the power demand on the fuel plant.

For fuel cell power plants that are configured to operate as long-term stationary power plants, efficient control of a rate of flow of the fuel feedstock into the fuel processing system and the resultant flow of hydrogen into the fuel cells of the plant requires precise management as a result of unpredictable disturbances that affect such power plants. A fundamental disturbance affecting load-following fuel cell power plants is a change in power demand. A change in power demand produces a change in the current drawn from the fuel cells of the plant, thus changing the optimal flow of hydrogen.

To react to changes in power demand, it is known that a fuel flow set point can be varied based on the current drawn from the fuel cells. This basic control mechanism is necessary, but not sufficient, to adequately control the flow of hydrogen-rich reformate fuel to fuel cell anodes. The basic control is not adequate because there are other disturbances that affect the power plant, even when power demand is constant.

One such disturbance is the fluctuating fuel heating value of a fuel such as natural gas. For example, if a fuel cell power plant has an expected operational duration of ten years, it is known that the heating value of natural gas supplied to the plant will vary significantly over such a ten year span.

A second common disturbance includes changes in fuel processing system hydrogen conversion efficiency. As an example, in a catalytic steam reformer, it is known that the effectiveness of the catalysts deteriorates over any given reformer life span. A third disturbance giving rise to current transients is changes in a steam-carbon ratio within the reformer.

Such changes may arise from variations in performance of a steam ejector resulting from mechanical degradation of the ejector or other performance variations of the ejector and related apparatus.

As a fuel cell power plant operates, for purposes of power plant efficiency, transient performance, and reformer durability, it is important to maintain anode utilization within a certain optimal performance range. For an exemplary fuel cell power plant, that optimal anode utilization range is between about 78 percent (%) and about 84%. (For purposes herein, by the phrase “anode utilization” it is meant that hydrogen fuel at the anode catalyst is dissociated into hydrogen ions and electrons. For example, if the anode utilization is 82%, that means 82% of the supply of hydrogen fuel is transformed into water at the cathode, while the remaining 18% of hydrogen fuel passes out of the anode flow field within the anode exhaust stream.) For most fuel cells it is known that having the anode utilization exceed the optimal range gives rise to damage to the anode catalyst and/or support materials for the catalyst. In contrast, operating the fuel cell at an anode utilization below the optimal range causes loss of valuable hydrogen fuel.

An effort to maintain anode utilization within the optimal range while the fuel cell power plant experiences one or more of the disturbances described above has produced acceptable results. In a PAFC power plant, this effort includes careful monitoring of a temperature within a reformer that receives heat from the ignited fuel cell anode exhaust. A feedback system for a PEM power plant is described in the aforesaid U.S. Pat. No. 6,818,336. If the anode utilization of the fuel cells exceeds the optimal range, more hydrogen will be used at the anode and therefore less hydrogen will be in the anode exhaust stream. Consequently, the amount of energy in the burner device from the exhaust stream will be less and temperature sensors within the reformer will sense a decrease in the temperature within the reformer. The decrease in the sensed temperature within the reformer is then communicated to a controller which increases a rate of flow of the fuel feedstock into the reformer. This in turn provides a greater amount of hydrogen fuel to the anode flow field to bring the anode utilization back down within the optimal range.

Similarly, if the anode utilization of the fuel cells decreases below the optimal range, less hydrogen fuel is used at the anode and therefore more hydrogen is within the anode exhaust stream that is fed to the burner device. Consequently, because the burner device has more fuel a temperature within the reformer will increase. The reformer temperature sensors will then communicate the increase in temperature to the controller, which in turn decreases the rate of flow of the fuel feedstock into the reformer. This provides less hydrogen fuel to the anode flow field to bring the anode utilization back up to within the optimal range.

In manufacture of a fuel cell power plant including such a reformer temperature control system for anode utilization, the power plant is typically tuned during factory testing by establishing a reformer temperature set point as a function of fuel cell current using sensitive (e.g., gas chromatography) measurements to establish reformer temperatures that correspond to anode utilization within an optimal range.

While the reformer temperature control system provides acceptable operation of the fuel cell power plant, the system involves great costs and requires enormous care. For example, if the fuel cell power plant is designed and manufactured to have a ten-year life span, the temperature sensors within the reformer must generate precise readings within exceedingly harsh conditions for the entire ten years. It is known that steam temperatures passing through stainless steel tubes in a catalytic bed within a catalytic steam reformer often exceed 650 degrees Celsius (C.°), while reformer temperatures may be below freezing when the plant is not operating and exposed to ambient conditions. Additionally, acceptable temperature sensors are typically threaded into such tube assemblies within sealed reformer containers with wire communication links passing through the containers. If such a temperature sensor malfunctions, it is extremely costly and disruptive to operation of the power plant to remove and replace the broken sensor within the complex reformer of the fuel processing system. Moreover, such sensors are necessarily very expensive.

Consequently, there is a need for a fuel cell power plant that includes an efficient and inexpensive system for control of anode utilization during steady-state operation of the plant as well as during electrical current transients resulting from various types of disturbances.

### SUMMARY

The disclosure is directed to an anode utilization control system for a fuel cell power plant for generating electrical current from an oxidant stream and a hydrogen-rich fuel stream. The system includes at least one fuel cell including an anode catalyst and a cathode catalyst secured to opposed sides of an electrolyte, an anode flow field defined in fluid communication with the anode catalyst and with a fuel inlet line for directing flow of the hydrogen-rich fuel stream from the fuel inlet line adjacent the anode catalyst and out of the anode flow field through an anode exhaust. The fuel cell also includes a cathode flow field defined in fluid communication with the cathode catalyst and with a source of the oxidant for directing flow of the oxidant stream from an oxidant inlet line adjacent the cathode catalyst and out of the cathode flow field through a cathode exhaust.

The power plant also includes a fuel processing system for generating the hydrogen-rich fuel stream from a fuel feedstock. The fuel processing system has a burner device configured to transmit heat to an endothermic reacting reformer by either transmitting heat directly into the reformer by conduction and convection through a heat transfer line from fuel cell anode exhaust ignited within the burner device, or by igniting fuel cell anode exhaust within the burner device to generate steam within a boiler of the burner device and directing the steam from the boiler through a steam transfer line into the reformer that is secured in fluid communication with the steam transfer line. A fuel feedstock inlet directs the fuel feedstock into the reformer to be reformed into the hydrogen-rich fuel stream. The reformer is also secured in fluid communication with the fuel inlet line for directing the reformed hydrogen-rich fuel stream through the fuel inlet line into the fuel cell. A burner feed line is secured in fluid communication between the burner device and the anode exhaust for directing an anode exhaust stream into the burner device to be burned and out of the burner device through the reformer, and out of the reformer through a burner exhaust. Heat is transferred by way of conduction from the burner device to either the endothermic reacting reformer directly, or to generate steam within a steam generator component of the burner device, which steam is then directed to the endothermic reacting reformer.

A key component of the system is an oxygen sensor that is secured in fluid communication with the burner exhaust for sensing a concentration of oxygen within the burned anode exhaust stream passing out of the burner device and reformer through the burner exhaust. An oxygen sensor controller is also secured in communication between the oxygen sensor and a fuel flow control valve that is secured to the fuel feedstock inlet line. The oxygen sensor controller is configured to selectively control flow of the fuel feedstock into the reformer in response to sensed oxygen concentrations within the burned anode exhaust stream.

The anode utilization control system may be used to maintain anode utilization by the fuel cell within an optimal anode utilization range. As described above, “anode utilization” means that hydrogen fuel at the anode catalyst is dissociated into hydrogen ions and electrons. (For purposes of efficiency herein, the phrase “anode catalyst” is used interchangeably with the word “anode” to mean the same fuel cell component.) If the anode utilization of the fuel cell exceeds the optimal range, more hydrogen will be used at the anode and therefore less hydrogen will be at the anode exhaust stream. Therefore, the amount of energy directed to the reformer burner device from the anode exhaust stream will decrease so that less oxygen is consumed in burning the hydrogen fuel within the burner device. Consequently, an amount of oxygen within the burner exhaust will increase. The oxygen sensor will sense this increase and then communicate to the oxygen sensor controller to increase a rate of flow of the fuel feedstock into the reformer. In contrast, if the anode utilization of the fuel cell decrease below the optimal range less hydrogen fuel is used at the anode and therefore more hydrogen is within the anode exhaust stream that is fed into the burner device. Consequently because more hydrogen is available within the burner device, more oxygen will be consumed and the amount of oxygen within the burner exhaust will decrease. The oxygen sensor will sense this decrease and communicate to the oxygen sensor controller to decrease the rate of flow of the fuel feedstock into the reformer. An exemplary oxygen sensor may be a wide-range air fuel sensor that utilizes a Nernst cell to generate a voltage responsive to an oxygen concentration within the burner exhaust.

Use of the present oxygen sensor and oxygen sensor controller to control anode utilization provides many benefits. First, the oxygen sensor may be placed at a location adjacent the burner exhaust that is much easier to access for purposes of efficiency of installation, maintenance and replacement of the sensor without significant disruption to the operation of the power plant. Second, the oxygen sensor provides rapid indications of changes in anode utilization without a need to await for subsequent changes in temperatures within the reformer. Additionally, use of the present oxygen sensor and oxygen sensor controller to control anode utilization reduces or eliminates any need for time-consuming and expensive factory-tuning of a schedule for reformer temperature set point as function of fuel cell current.

Perhaps most importantly, experimentation with the present anode utilization control system demonstrates that adjusting flow of fuel feedstock into the reformer to maintain a constant burner exhaust oxygen concentration while holding electrical current produced by the power plant fixed and while holding burner air fixed, effectively maintains anode utilization within a optimal utilization band, and thereby eliminates any transient impact resulting from disturbances in fuel heating value of the fuel feedstock, hydrogen production efficiency the fuel processing system, and/or a changes in a steam carbon ratio within the fuel processing system.

Accordingly, it is a general purpose of the present disclosure to provide an anode utilization control system for a fuel cell power plant utilizing a reformer produced fuel that overcomes deficiencies of the prior art.

It is a more specific purpose to provide an anode utilization control system for a fuel cell power plant that increases operating efficiencies of the power plant and decrease manufacture and maintenance costs of the plant.

These and other purposes and advantages of the present anode utilization control system for a fuel cell power plant will become more readily apparent when the following description is read in conjunction with the accompanying drawings.

### BRIEF DESCRIPTION OF DRAWING

FIG. 1 is a simplified schematic representation of an anode utilization control system for a fuel cell power plant of the present disclosure.

### DESCRIPTION OF THE PREFERRED EMBODIMENTS

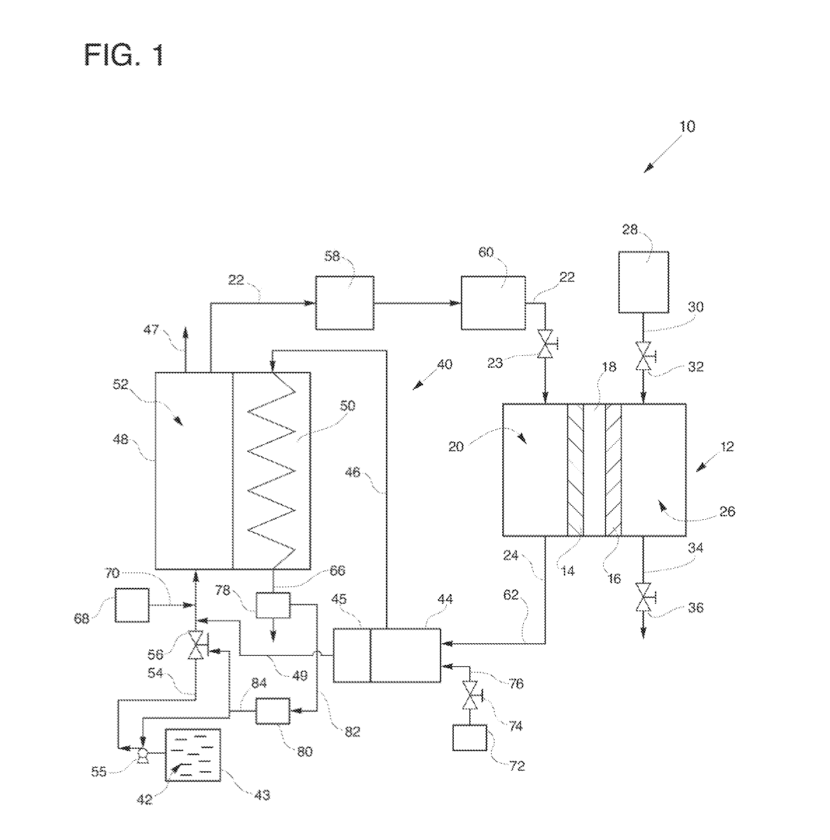

Referring to the drawings in detail, an anode utilization system for a fuel cell power plant is shown in FIG. 1 and is generally designated by the reference numeral 10. The system or power plant 10 includes at least one fuel cell 12 including an anode catalyst 14 and a cathode catalyst 16 secured to opposed sides of an electrolyte 18, an anode flow field 20 defined in fluid communication with the anode catalyst 14 and with a fuel inlet line 22 for directing flow of a hydrogen-rich fuel stream from the fuel inlet line 22 and through the anode flow field 20, adjacent the anode catalyst 14 and out of the anode flow field 20 through an anode exhaust 24 and anode exhaust valve 25. The fuel inlet line 22 includes a fuel inlet valve 23 for selectively controlling flow of the fuel into the anode flow field 20.

The fuel cell 12 also includes a cathode flow field 26 defined in fluid communication with the cathode catalyst 16 and with an oxidant source 28 for directing flow of an oxidant stream from an oxidant inlet line 30 through the cathode flow field 26 adjacent the cathode catalyst 16 and out of the cathode flow field 26 through a cathode exhaust 34 and cathode exhaust valve 36. An oxidant inlet valve 32 is secured to the oxidant inlet line 30 for selectively controlling flow of the oxidant stream from the oxidant source 28 into the cathode flow field 26.

The power plant 10 also includes a fuel processing system 40 for generating the hydrogen-rich fuel stream from a fuel feedstock 42 stored within a fuel feedstock source 43. The fuel processing system 40 has a burner device 44 configured to transmit heat to an endothermic reacting reformer 48 by either transmitting heat directly into the reformer 48 by conduction and convection through a heat transfer line 46 from fuel cell anode exhaust ignited within the burner device 44, or by igniting the fuel cell anode exhaust within the burner device 44 to generate steam within a boiler 45 of the burner device 44 and directing the steam from the boiler through a steam transfer line 49 into the reformer 48 that is secured in fluid communication with the steam transfer line 49. For example, if the fuel processing system 40 is for a PAFC system, the ignited fuel cell anode exhaust stream would transfer heat directly through the heat transfer line 46. If the fuel processing system was configured for a PEM system, the ignited fuel cell anode exhaust stream would generate steam within the boiler 45 that would be transferred to the reformer 48 through the steam transfer line 49. The reformer 48 may be any heated reformer means 48 for generating a hydrogen-rich fuel stream from a fuel feedstock 42, wherein the reformer 48 requires heat, such as a catalytic steam reformer. The reformer 48 includes a heat-exchange component 50 secured in heat exchange relationship with a fuel passage component 52 of the reformer 48. The heat-exchange component 50 may be configured to consist of a plurality of tubes (not shown) through which steam passes to a reformer steam exhaust 47, and wherein the tubes are surrounded by a catalyst bed (not shown).

A fuel feedstock inlet line 54 directs the fuel feedstock 42 through a fuel pump 55 configured to operate alone or in conjunction with a feedstock fuel flow control valve 56 into the reformer 48 to be reformed into the hydrogen-rich fuel stream. The fuel flow control valve 56 and fuel pump 55 may be any flow control device means 56, 55 capable of performing the described function of pumping the fuel feedstock 42 into the reformer 48 at variable rates, such as a standard impeller pump, centrifugal pump, gravity head and/or a pressurized container 43 and control valve 56, etc. The steam inlet line 49 from the boiler 45 is also secured in fluid communication with the fuel feedstock inlet line 54 down stream from the flow control device 55, 56 to supply steam to the reformer 48. Additionally, for some embodiments, such as a PAFC system, a steam or water source 68 may be secured in fluid communication through a second steam inlet line 80 with the fuel feedstock inlet line 54 down stream from the flow control device 55, 56 to supply steam to the reformer 48. In such high temperature PAFC systems, the steam source 68 may be system coolers (not shown) so that no boiler 45 is required. The reformer 48 is also secured in fluid communication with the fuel inlet line 22 for directing the reformed hydrogen-rich fuel stream through the fuel inlet line 22 into the fuel cell 12. The fuel processing system 40 may also include further components secured in fluid communication with the fuel inlet line 22, such as a shift converter 58 and an a selective oxidizer 60 to further condition the fuel stream and process by-products thereof.

A burner feed line 62 is secured in fluid communication between the burner device 44 and the anode exhaust 24 for selectively directing flow of an anode exhaust stream from the anode exhaust 24 into the burner device 44 to be burned. The burned anode exhaust stream is then directed to flow out of the burner device 44 through a heat transfer line 46 into and through the heat exchange component 50 of the reformer 52. A burner exhaust 66 directs flow of the burned anode exhaust stream out of the reformer 48 and/or out of the plant 10. Additionally, a burner air supply 72 may provide air at pre-determined fixed or variable rates through a burner air supply control valve 74 secured on a burner air feed line 76 that is secured in fluid communication between the burner air supply 72 and the burner device 44.

The anode utilization control system 10 also includes an oxygen sensor 78 that is secured in fluid communication with the burner exhaust 66 for sensing a concentration of oxygen within the burned anode exhaust stream passing out of the burner exhaust 66. An oxygen sensor controller 80 is also secured in communication, such as through communication lines 82, 84 between the oxygen sensor 78 and the fuel flow control valve 56 that is secured in fluid communication with the fuel feedstock inlet line 54. The oxygen sensor controller 80 is configured to selectively control flow of the fuel feedstock 42 out of the fuel feedstock source 43 and into the reformer 48 in response to oxygen concentrations sensed by the oxygen sensor 78 within the burned anode exhaust stream passing through the burner exhaust 66. The oxygen sensor controller may achieve such control of the rate of flow of the fuel feedstock into the reformer 48 by executing control over the fuel flow control valve 56 and/or the fuel pump 55.

It is noted that the communication lines 82, 84 between the oxygen sensor control 80 and the fuel flow control valve 56 and/or fuel pump 55 may be traditional electric transmission lines, or in contrast may be any technology capable of signaling sensed information, such as wireless transmission, mechanical signals and mechanical or manual actuators, electro-mechanical apparatus, etc. The oxygen sensor controller 80 may be any oxygen sensor controller 80 capable of performing the functions described herein. For example, the controller 80 may be a computer, a micro-computer, electro-mechanical switches, manually operated actuators activated to response to visual indicators, such as gauges, lights, etc. The oxygen sensor 78 may be any oxygen sensor capable of measuring a concentration of oxygen within a burned anode exhaust stream within a tolerance of plus or minus 5.0%. An exemplary oxygen sensor 78 may be a wide-range air fuel sensor that utilizes a Nernst cell to generate a voltage responsive to changes in oxygen concentration within the burner exhaust 66. A example of an acceptable oxygen sensor is an oxygen sensor sold by the model name “Lambda Sensor” in the “LRU” product line, manufactured by the Robert Bosch LLC company of 2800 S. 25th Ave. Broadview, Ill. 60155.

Exemplary tests have been performed using the anode utilization control system 10 of the present invention to establish the value of adjusting flow of the fuel feedstock 42 into the reformer 48 to maintain a constant burner device 44 exit oxygen concentration while holding fuel cell electrical current output constant and while providing a constant supply of air to the burner device 44. These tests are documented in Table 1, and they provide evidence that maintaining a constant burner exhaust oxygen concentration with electrical current output constant and while providing a constant supply of air to the burner device 44 effectively eliminates any electrical current transients resulting from; a. disturbances in fuel heating value; b. disturbances in fuel processing system 40 production efficiency; and, c. disturbances in a steam-carbon ratio. The fuel cell subject to analysis in Table 1 has an optimal anode utilization range of between about 78% and 84%. (For purposes herein, the word “about” is to mean plus or minus 15%). In all scenarios, the air supplied to the burner device is maintained at a constant flow rate. In an embodiment of the present system 10, air would be supplied to the burner device at a constant rate as a function of current.

TABLE 1
Example of how fuel flow feedback using burner oxygen concentration
measurements effectively rejects disturbances
to maintain correct anode utilization

| | | Parameters | | | | | |
|---|---|---|---|---|---|---|---|
| | | Fuel | Hydrogen | Steam | | Oxygen | |
| | | LHV, | production | carbon | Anode | Concentration | Fuel flow, |
| # | Scenario | kJ/gmol | efficiency | ratio | utilization | leaving burner | gmol/s |
| 1 | Base scenario | 802.10 | 113% | 3.25 | 80.0% | 3.0% | 1.451 |
| 2a | Disturbance in fuel | 866.27 | 113% | 3.25 | 74.1% | 0.2% | 1.451 |
| | LHV, uncorrected | | | | | | |
| 2b | Disturbance in fuel | 866.27 | 113% | 3.25 | 79.8% | 3.0% | 1.348 |
| | LHV, corrected by | | | | | | |
| | control scheme | | | | | | |
| 3a | Disturbance in | 802.10 | 102% | 3.25 | 89.0% | 6.8% | 1.450 |
| | hydrogen production | | | | | | |
| | efficiency, | | | | | | |
| | uncorrected | | | | | | |
| 3b | Disturbance in | 802.10 | 102% | 3.25 | 80.3% | 3.0% | 1.606 |
| | hydrogen production | | | | | | |
| | efficiency, corrected | | | | | | |
| | by control scheme | | | | | | |
| 4a | Disturbance in | 802.10 | 113% | 4 | 80.0% | 2.6% | 1.451 |
| | steam-carbon, | | | | | | |
| | uncorrected | | | | | | |
| 4b | Disturbance in steam- | 802.10 | 113% | 4 | 80.8% | 3.0% | 1.436 |
| | carbon, corrected by | | | | | | |
| | control scheme | | | | | | |

Reviewing Table 1, we see a “Base scenario” identified by reference numeral 1 in the column on the left side of the Table. This Base scenario identifies a fuel heating value (“Fuel LHV”) of 802.10 kJ/gmol; a “Hydrogen production efficiency” of the fuel processing system of 113%; a “Steam carbon ratio” of 3.25; an “Anode utilization” of 80.0%; an “Oxygen concentration leaving burner exhaust” of 3.0%; and, a feedstock “fuel flow” of 1.451 gmol/s. In the Scenarios that follow in Table 1 the three above described disturbances are evaluated.

In Scenario 2a we see an uncorrected disturbance in the fuel heating value from 802.10 kJ/gmol to 866.27 kJ/gmol which results in an anode utilization of 74.1%, well outside the optimal anode utilization range. In scenario 2b we see that the fuel flow has been changed from 1.451 gmol/s to 1.348 gmol/s to produce a base scenario oxygen concentration of 3.0%. This results in producing an anode utilization of 79.8%, which is back within the optimal range.

In scenario 3a, we see a disturbance in the hydrogen production efficiency of the fuel processing system declining from the base scenario of 113% to 102%. This results in an anode utilization of 89.0%, well above the optimal range. Scenario 3b, shows an increase in the fuel flow from the 3a scenario of 1.451 gmol/s to 1.606 gmol/s, which again produces a base scenario oxygen concentration of 3.0%. This also results in an anode utilization of 80.3%, which is back within the optimal range.

In scenario 4a, Table 1 shows a disturbance in the steam carbon ratio from the base scenario of 3.25 to a ratio of 4, which, while keeping the anode utilization within the optimal range, nonetheless results in a decrease in oxygen concentration leaving the burner device from the base scenario of 3.0% to 2.6%. In scenario 4b, we see that by the automated expedient of decreasing the fuel flow from the 4a scenario of 1.451 gmol/s to 1.436 gmol/s in order to maintain the oxygen concentration leaving the burner device at 3.0%, the present invention only changes the anode utilization from 80.0% to only 80.8%, which is also well within the optimal range of anode utilization.

Scenarios of 4a and 4b show that while a significant change in steam carbon ratio may not directly force the anode utilization outside an optimal range, nonetheless, the control scheme of this system 10 of adjusting fuel flow to maintain a constant oxygen concentration leaving the burner exhaust 66 results in keeping the anode utilization within the optimal range, while simultaneously decreasing fuel flow to the reformer to thereby more efficiently use the fuel. Therefore, the exemplary data presented in Table 1 clearly establish that by sensing oxygen concentration within the burner exhaust 66 and by adjusting a rate of flow of fuel feedstock into the reformer to constantly maintain an oxygen concentration of about 3.0% in the burner exhaust, the present system 10 effectively rejects any negative impact on anode utilization resulting from the three described, common disturbances.

In use of the present anode utilization control system for a fuel cell power plant 10, prior to initiating ordinary operation and during factory testing, the power plant 10 would be tuned to establish an optimal oxygen concentration set point within the burner exhaust 66 (e.g., such as 3.0% in Table 1) that will maintain the anode utilization within a predetermined optimal anode utilization range for the power plant 10 while the plant 10 experiences disturbances in fuel heating value, fuel processing system hydrogen production efficiency and/or steam to carbon ratios. (For purposes herein the phrase “optimal anode utilization range” is to mean a range of hydrogen use at an anode catalyst that causes no damage to the anode catalyst and related support materials and that also efficiently utilizes the hydrogen fuel.)

The oxygen sensor controller 80 would also be calibrated or otherwise controlled to adjust the flow rate of fuel feedstock 42 into the reformer 48 in response to the sensed oxygen concentrations by the oxygen sensor 78 in order to maintain the oxygen concentration within the burner exhaust 66 at about the predetermined oxygen concentration set point. This results in the anode utilization remaining within the predetermined optimal anode utilization range during ordinary operation of the fuel cell power plant 10.

The present disclosure also includes a method of controlling anode utilization in the fuel cell power plant 10. The method includes directing flow of a hydrogen-rich fuel stream adjacent an anode catalyst 14 of a fuel cell and out of the fuel cell 12 as an anode exhaust stream while directing flow of an oxidant stream adjacent a cathode catalyst 16 of the fuel cell and out of the fuel cell 12; directing flow of some or all of the anode exhaust stream into a burner device 44 of a fuel processing system 40 and burning the anode exhaust stream within the burner device 44 to transmit heat to an endothermic reacting reformer 48 by either transmitting heat directly into the reformer 48 through conduction and convection, or by generating steam within a boiler 45 adjacent the burner device 44 and directing the heated steam into the reformer 48; directing a fuel feed stock 42 into a reformer 48 to reform the fuel feedstock 42 into the hydrogen-rich fuel stream; sensing an oxygen concentration within the burned anode exhaust stream passing out of the burner device 44; and, adjusting a rate of flow of the fuel feedstock 42 into the reformer 48 in response to the sensed oxygen concentration within the burned anode exhaust stream. Additionally, the method may also include first establishing an optimal oxygen concentration set point for the fuel cell power plant 10 to maintain anode utilization within a predetermined optimal anode utilization range for the power plant 10 while the plant 10 experiences disturbances in fuel heating value, fuel processing system hydrogen production efficiency and/or steam to carbon ratios. Then, the rate of flow of the fuel feedstock 42 into the reformer 48 may be adjusted in response to the sensed oxygen concentrations in the burned anode exhaust stream to maintain the oxygen concentration at about the optimal oxygen concentration set point.

Use of the oxygen sensor 78 to monitor oxygen concentrations within the burner exhaust 66 may also be utilized for other valuable aspects of increasing efficient operation of the fuel cell power plant 10. For example, the oxygen concentration may be utilized along with other power plant operation parameters to tune or determine a set point for fuel flow rates. Additionally, a fuel flow rate set point may based upon measured current from the fuel cell 12, and then that set point can be modified based upon feedback from the oxygen sensor 78. Also, the fuel flow set point established by the actual fuel cell 12 current modified by the oxygen sensor 78 feedback may also be further modified by establishing a multiplication factor which is a function of how far the actual oxygen concentration measurement is from an oxygen measurement set point, and multiplying the set point based on actual current by the multiplication factor. The multiplication factor may also be restricted to be within a specific optimal range.

While the above disclosure has been presented with respect to the described and illustrated embodiments of the anode utilization control system for a fuel cell power plant 10, it is to be understood that the disclosure is not to be limited to those alternatives and described embodiments. For example, the system 10 may be utilized with fuel cells employing phosphoric acid electrolytes, proton exchange membrane (“PEM”) electrolytes, or other known electrolytes. Additionally, the system 10 may include other features for system protection, such as temperature sensors (not shown) monitoring temperatures of the reformer 48 and linked to alarms in the event the temperature of the reformer 48 exceeds a predetermined upper safety limit. Accordingly, reference should be made primarily to the following claims rather than the forgoing description to determine the scope of the disclosure.

What is claimed is:

1. An anode utilization control system (10) for a fuel cell (12) power plant for generating electrical current from an oxidant stream and a hydrogen-rich fuel stream, the system (10) comprising:
a. at least one fuel cell (12) including an anode catalyst (14) and a cathode catalyst (16) secured to opposed sides of an electrolyte (18), an anode flow field (20) defined in fluid communication with the anode catalyst (14) and with a fuel inlet line (22) for directing flow of the hydrogen-rich fuel stream from the fuel inlet line (22) adjacent the anode catalyst (14) and out of the anode flow field (20) through an anode exhaust (24) as an anode exhaust stream, a cathode flow field (26) defined in fluid communication with the cathode catalyst (16) and with a source of the oxidant (28) for directing flow of the oxidant stream from an oxidant inlet line (30) adjacent the cathode catalyst (16) and out of the cathode flow field (26);
b. a fuel processing system (10) for generating the hydrogen-rich fuel stream from a fuel feedstock (42), the fuel processing system (10) including a burner device (44) secured in fluid communication with the anode exhaust (24) and secured in heat transfer relationship with an endothermic reacting reformer (48), the burner device (44) being configured to transmit heat to the reformer (48) by one of transmitting heat directly into the reformer (48) through conduction and convection through a heat transfer line (46) secured in fluid communication with the anode exhaust stream burned within the burner device (44), or by burning the anode exhaust stream within the burner device (44) to generate steam within a boiler (45) secured adjacent the burner device (44) and directing the steam through a steam transfer line (49) into the reformer (48) that is secured in fluid communication with the heat transfer line (46) or the steam transfer line (49), the reformer (48) also being secured in fluid communication with a fuel feedstock inlet line (54) for directing the fuel feedstock (42) into the reformer (48) to be reformed into the hydrogen-rich fuel stream, the reformer (48) also being secured in fluid communication with the fuel inlet line (22) for directing the reformed hydrogen-rich fuel stream through the fuel inlet line (22) into the fuel cell (12);
c. a burner feed line (62) secured in fluid communication between the burner device (44) and the anode exhaust (24) for directing the anode exhaust stream into the burner device (44) to be burned and out of the burner device (44) through a burner exhaust (66);
d. an oxygen sensor (28) secured in fluid communication with the burner exhaust (66) for sensing a concentration of oxygen within the burned anode exhaust stream passing out of the burner device (44) through the burner exhaust (66); and,
e. an oxygen sensor controller (80) secured in communication between the oxygen sensor (78) and a fuel flow control device (55, 56) secured in fluid communication with the fuel feedstock inlet line (54), the oxygen sensor controller (80) configured to selectively control flow of the fuel feedstock (42) through the flow control device (55, 56) into the reformer (48) in response to sensed oxygen concentrations within the burned anode exhaust stream.

2. The anode utilization control system (10) of claim 1 wherein the flow control device includes a fuel pump (55) secured in fluid communication with the feedstock inlet line (54) for selectively pumping the fuel feedstock (52) into the reformer (48) in response to the sensed oxygen concentration within the burned anode exhaust stream.

3. The anode utilization control system (10) of claim 1 wherein the reformer (48) is a catalytic steam reformer (48).

4. The anode utilization control system (10) of claim 1 wherein the electrolyte (18) is a phosphoric acid electrolyte (18).

5. The anode utilization control system (10) of claim 1 wherein the electrolyte (18) is a proton exchange membrane (PEM) electrolyte (18).

6. A method of controlling anode utilization in a fuel cell power plant (10), the method comprising:
a. directing flow of a hydrogen-rich fuel stream adjacent an anode catalyst (14) of a fuel cell (12) and out of the fuel cell (12) as an anode exhaust stream while directing flow of an oxidant stream adjacent a cathode catalyst (16) of the fuel cell (12) and out of the fuel cell (12);
b. directing flow of some or all of the anode exhaust stream into a burner device (44) of a fuel processing system (40) and burning the anode exhaust stream within the burner device (44) to generate heat;
c. directing the heat and a fuel feed stock (42) into a reformer (48) to reform the fuel feedstock (42) into the hydrogen-rich fuel stream;
d. sensing an oxygen concentration within the burned anode exhaust stream passing out of the burner device (44); and,
e. adjusting a rate of flow of the fuel feedstock (42) into the reformer (48) in response to the sensed oxygen concentration within the burned anode exhaust stream.

7. The method of claim 6 further comprising, while sensing the oxygen concentration within the burned anode exhaust stream, establishing an optimal oxygen concentration set point for the fuel cell power plant (10) that maintains anode utilization within a predetermined optimal anode utilization range for the power plant (10) while the plant (10) experiences disturbances in fuel heating value, fuel processing system hydrogen production efficiency and/or steam to hydrogen ratios.

8. The method of claim 7, further comprising then adjusting the rate of flow of the fuel feedstock (42) into the reformer (48) in response to variations in the sensed oxygen concentrations in the burned anode exhaust stream to maintain the oxygen concentration at about the optimal oxygen concentration set point.

9. The method of claim 6, further comprising maintaining a flow rate of air to the burner device (44) that is a function of a fixed value based on fuel cell (12) current.

10. The method of claim 6, further comprising monitoring temperatures of the reformer (48), and activating an over-temperature alarm whenever temperatures of the reformer (48) exceed a predetermined upper temperature limit.

11. The method of claim 6, further comprising, after sensing the oxygen concentration, integrating at least a power plant (10) operating parameter of fuel cell (12) current to establish a fuel flow set point.

12. The method of claim 6, further comprising calculating a fuel flow set point based upon measured current from the fuel cell (10) and then modifying the measured current fuel flow set based on the sensed oxygen concentrations.

13. The method of claim 12, further comprising modifying the fuel flow set point established by the actual fuel cell (12) current as modified by the sensed oxygen concentrations by establishing a multiplication factor which is a function of how far the actual sensed oxygen concentration measurements are from a predetermined oxygen measurement set point, and multiplying the set point based on actual current as modified by the sensed oxygen concentrations by the multiplication factor.
